(19) United States
(12) Patent Application Publication
(10) Pub. No.: US 2008/0144112 A1
(43) Pub. Date: Jun. 19, 2008

(54) APPARATUS AND METHOD FOR DRIVING SELF-EMISSION DISPLAY PANEL

(75) Inventor: Gwon-jin MOON, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/736,836

(22) Filed: Apr. 18, 2007

(30) Foreign Application Priority Data
Oct. 18, 2006 (KR) 2006-101393

(51) Int. Cl. G06K 15/00

(52) U.S. Cl. 358/3.03

(57) ABSTRACT

Provided are an apparatus and a method for driving a self-emission display panel. A sustain pulse (STP) controller calculates an automatic power control (APC) level of image data having an input grayscale and outputs a STP corresponding to the calculated APC level. A sub-field (SF) controller which applies a dithering method to each SF corresponding to the input grayscale to generate SF data for expressing the input grayscale so as to reduce the number of cells simultaneously emitting light in a SF. A sustain/scan driver generates sustain/scan pulses from the output STP to drive the self-emission display panel. An address electrode driver generates an address driving signal corresponding to the input grayscale from the generated SF data to drive the self-emission display panel.

### CROSS-REFERENCE TO RELATED APPLICATIONS

This application priority from Korean Patent Application No. 2006-101393, filed Oct. 18, 2006, in the Korean Intellectual Property Office, the entire contents of which is incorporated herein by reference.

### BACKGROUND OF THE INVENTION

1. Field of the Invention

Apparatuses and methods consistent with the present invention relate to driving a self-emission display panel, and more particularly, to driving a self-emission display panel by which the number of sustain pulses (STPs) necessary for emitting image data can be reduced according to a grayscale of the image data and a consumed power can be maintained constant.

2. Description of the Related Art

Plasma display panels (PDPs) use an address display separating (ADS) driving method, i.e., a method of dividing a frame into a plurality of sub-fields (SFs) and then driving the SFs, in order to realize grayscales of images. FIG. 1 is a view illustrating an example of a frame which is displayed for 1/60 second and divided into four SFs. Referring to FIG. 1, each of the SFs is divided into a reset section (not shown) for initializing a state of a cell, an address section (A) for selecting a discharge cell, and a sustain section (S) for realizing a grayscale according to the number of times discharge is performed.

If a frame is divided into four SFs, a grayscale of an image may be expressed from “0” to “15” as shown in FIG. 2. If the grayscale is expressed with “15,” a conventional PDP must turn on all of first through fourth SFs (SF1-SF4). Also, the number of sustain pulses (STPs) applied to each of the first through fourth SFs (SF1-SF4) is proportional to a weight of each of the first through fourth SFs (SF1-SF4).

Electrode lines of a PDP have an n×m matrix structure as shown in FIG. 3. A plurality of address electrode lines A (A₁-Aₘ) are arranged in a row direction, while electrode lines Y (Y₁-Yₙ) and electrode lines X (X₁-Xₙ)are arranged in a column direction.

Cells are positioned at intersecting points among the address electrode lines, the electrode lines Y and the electrode lines X, and the number of STPs generated in each of SFs is adjusted according to a driving signal applied to the address electrode lines to appropriately express grayscales of the cells.

For example, if all of Standard Definition (SD) cells, each having first through fourth SFs (SF1-SF4) are expressed with “Full White” as a grayscale 15, the first through fourth SFs (SF1-SF4) of all of the SD cells must simultaneously emit light. This is because input grayscale 15 must be emitted from all of the first through fourth SFs (SF1-SF4). In a case of SD cells, 852×480×3 cells simultaneously emit light. Here, “3” denotes red, green and blue cells (R, G, and B) cells.

If a current flowing in a STP in a cell is “1,” and all of cells are expressed with grayscale 15, a peak current in each STP is “852×480×3.” This is because all cells are simultaneously turned on in each SF to emit light.

In a case of Full White grayscale 15, a peak current is as described above. However, the average current of a peak current for one frame is much smaller than “852×480'3.” Thus, if a peak current is generated by “852×480×3” voltage falling and rippling of driving waves become serious. As a result, each cell does not normally discharge.

If all cells are expressed with grayscale 15, a peak current corresponding to “852×3” flows in a scan line through electrode lines X and Y. In the case of a 42-inch PDP, each electrodes has a length of 900 mm or more. Thus, voltage falling occurs along electrode lines X and Y. As a result, luminance becomes non-uniform at parts adjacent to centers of the electrode lines X and Y and electrode pads.

Also, as shown in FIG. 4, if luminances of all of cells on a electrode line Y₁ are expressed with grayscale 15, cells in the center section of a electrode line Y₂ are expressed with a grayscale 0, and cells in other sections of the electrode line Y₂ are expressed with a grayscale 15, thus, a luminance difference occurs between the electrode lines Y₁ and Y₂. This is because a peak current corresponding to “852×3” flows on the electrode line Y₁, while a peak current corresponding to 50% of “852×3” flows on the electrode line Y₂.

When a circuit for driving a PDP is constituted, a peak current may become great resulting in an increase in the capacity of a switching element. Thus, cost of the switching element may be increased.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present invention is to provide an apparatus and a method for driving a self-emission display panel by which a maximum value of a peak current generated in a sustain section of a SF can be reduced to solve discharge, luminance deviation, and luminance difference problems, and a cost problem of a switching element.

In one aspect of the present invention, there is provided an apparatus for driving a self-emission display panel, including: a sustain pulse (STP) controller calculating an automatic power control (APC) level of image data having an input grayscale and outputting a STP corresponding to the calculated APC level; a sub-field (SF) controller generating SF data for applying a dithering method to each SF corresponding to the input grayscale to express the grayscale so as to reduce the number of cells simultaneously emitting light in a SF; a sustain/scan driver generating sustain/scan pulses from the output STP to drive the self-emission display panel; and an address electrode driver generating an address driving signal corresponding to the input grayscale from the generated SF data to drive the self-emission display panel.

If an average signal level (ASL) of the image data is greater than a reference ASL, the STP controller may transform the input grayscale to generate an output grayscale and calculate an APC level of the output grayscale.

If the ASL of the input grayscale is greater than the reference ASL, the STP controller may fix the APC level of the output grayscale to maintain the number of generated output STPs and a consumed power constant.

The STP controller may include: a first ASL/APC calculator calculating the ASL from the input grayscale of the image data and outputting the image data if the ASL is greater than the reference ASL; a grayscale transformer transforming the input grayscale of the output image data to generate the output grayscale; and a second ASL/APC calculator calculating the APC level of the generated output grayscale and outputting an output STP corresponding to the calculated APC level of the output grayscale.

If the calculated ASL is less than or equal to the reference ASL, the first ASL/APC calculator may calculate an APC level of the input grayscale using the calculated ASL and output an input STP corresponding to the calculated APC level of the input grayscale.

The grayscale transformer may transform the input grayscale into the output grayscale using Equation below:

$$Output Gray Scale = \frac{i ( N \times Input Gray Scale \times \frac{Reference ASL}{Input ASL} )}{N}$$

wherein i denotes an integer, N denotes the number of cells used for dithering, and ASL denotes the ASL calculated by the first ASL/APC calculator.

If the ASL of the input grayscale is greater than the reference ASL, the grayscale transformer may generate the output grayscale which is expressed with fractions from “0” to fractions of “1/N” (where N denotes the number of cells used for dithering).

The SF controller may generate the SF data using dithering on-off data set in each SF according to the input grayscale and express the dithering on-off data with fractions between “0” and “1.”

The SF controller may include: a SF storage storing the dithering-on off data of each SF corresponding to the input and output grayscales; and a SF generator generating the SF data using the set dithering on-off data of the each SF corresponding to one of the input and output grayscales.

The self-emission display panel may be an Active Matrix Organic Emitting Diode (AMOLED), plasma display panel (PDP), a surface-conduction electron-emitter display (SED), and a field emission display (FED).

There is provided a method of driving a self-emission display panel, including: calculating an APC level of image data having an input grayscale and outputting a STP corresponding to the calculated APC level; generating SF data for applying a dithering method to each SF corresponding to the input grayscale to express the grayscale so as to reduce the number of cells simultaneously emitting light in a SF; generating sustain/scan pulses from the output STP to drive the self-emission display panel; and generating an address driving signal corresponding to the input grayscale from the generated SF data to drive the self-emission display panel.

If an ASL of the image data is greater than a reference ASL, the input grayscale may be transformed to generate an output grayscale, and an APC level of the output grayscale may be calculated

If the ASL of the input grayscale is greater than the reference ASL, the APC level of the output grayscale may be fixed to maintain the number of generated output STPs and a consumed power constant.

The outputting of the STP may include: calculating the ASL from the input grayscale of the image data and outputting the image data if the ASL is greater than the reference ASL; transforming the input grayscale of the output image data to generate the output grayscale; and calculating the APC level of the generated output grayscale and outputting an output STP corresponding to the calculated APC level of the output grayscale.

If the calculated ASL is less than or equal to the reference ASL, an APC level of the input grayscale may be calculated using the calculated ASL, and an input STP corresponding to the calculated APC level of the input grayscale may be output.

If the ASL of the input grayscale is greater than the reference ASL, the output grayscale may be generated, wherein the output grayscale is expressed with fractions from “0” to fractions of “1/N” (where N denotes the number of cells used for dithering).

The SF data may be generated using dithering on-off data set in each SF according to the input grayscale, and the dithering on-off data may be expressed with fractions between “0” and “1.”

The SF data may be generated using the dithering on-off data of each SF corresponding to the input or output grayscale.

### BRIEF DESCRIPTION OF THE DRAWINGS

The above and other aspects of the present invention will become more apparent by describing in detail exemplary embodiments thereof with reference to the attached drawing figures, wherein;

FIG. 1 is a view illustrating related art example of a frame which is displayed for 1/60 second and divided into four sub-fields (SFs);

FIG. 2 is a related art table illustrating SF codes allocated to four SFs and corresponding grayscales;

FIG. 3 is a view schematically illustrating a related art plasma display panel (PDP) having an n×m matrix structure;

FIG. 4 is a view illustrating related art cells positioned on electrode lines Y1 and Y2;

FIG. 5 is a schematic block diagram of an apparatus for driving a self-emission display panel according to an exemplary embodiment of the present invention;

FIG. 6 is a schematic block diagram of an apparatus for driving a self-emission display panel according to another exemplary embodiment of the present invention;

FIG. 7 is an APC (automatic power control) table illustrating examples of sustain pulses (STPs) allocated with respect to APC levels;

FIG. 8 is a table illustrating an example of output grayscales into which input grayscales are transformed by a grayscale transformer of FIG. 6 according to load factors or ASLs;

FIG. 9 is a graph illustrating examples of the input and output grayscales of the table of FIG. 8;

FIG. 10 is a graph illustrating an example of APC level maintained constant when an ASL calculated by a second ASL/APC calculator is greater than a reference ASL;

FIG. 11A is a table illustrating an example of first dithering on-off data stored in a SF table storage of FIG. 6;

FIG. 11B is a table illustrating an example of second dithering on-off data stored in the SF table storage of FIG. 6;

FIG. 12 is a view illustrating an example of grayscale rules using dithering set by a SF generator illustrated in FIG. 6;

FIG. 13 is a view schematically illustrating examples of R sub-cells each having a 4×4 structure;

FIG. 14 is a table illustrating examples of output grayscales corresponding to input grayscales and dithering on-off data set for each of the output grayscales when an input ASL is 12;

FIGS. 15A and 15B are views illustrating an example of a process of applying dithering to output grayscales generated as illustrated in FIG. 13;

FIG. 15C is a view illustrating example of peak currents obtained by applying the related art to output grayscales obtained as illustrated in FIG. 13;

FIG. 16 is a flowchart of method for driving a self-emission display panel illustrated in FIG. 5, according to an exemplary embodiment of the present invention; and

FIG. 17 is a flowchart of a method for driving a self-emission display panel illustrated in FIG. 6, according to another embodiment of the present invention.

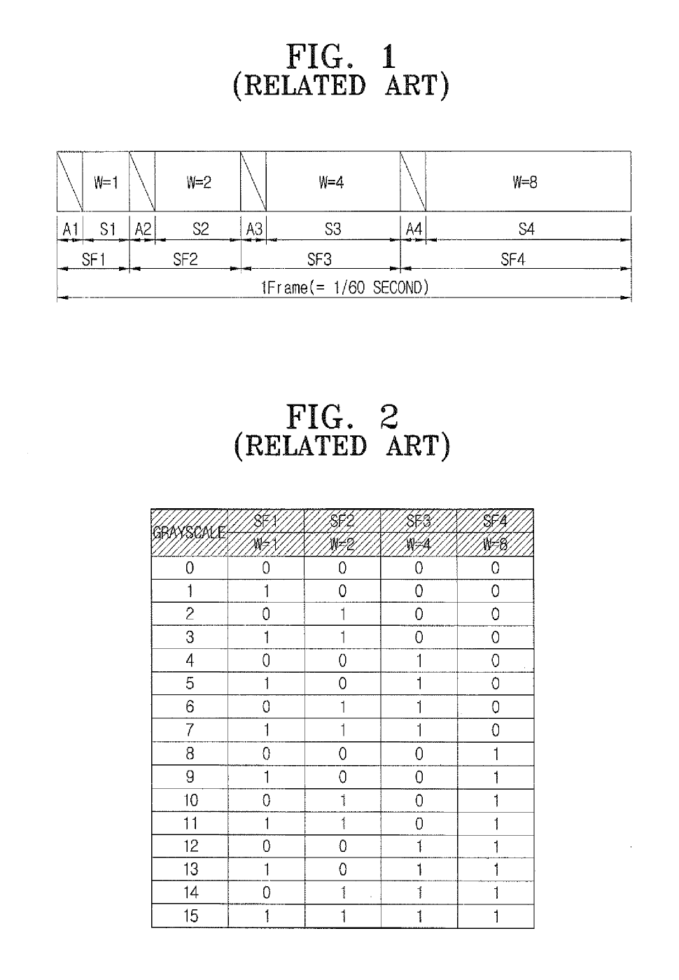

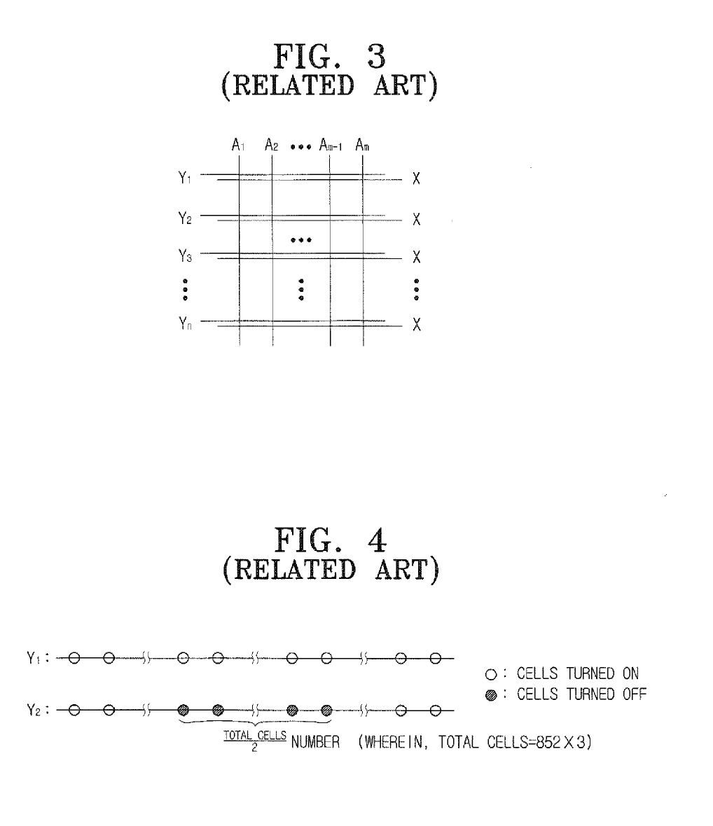

### DETAILED DESCRIPTION OF EXEMPLARY EMBODIMENTS OF THE PRESENT INVENTION

Hereinafter, exemplary embodiments of the present invention will be described in detail with reference to the accompanying figures.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

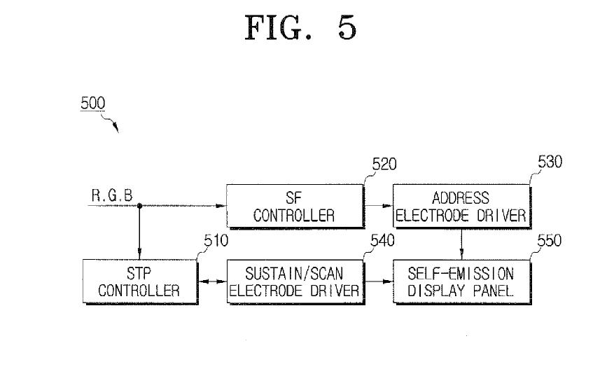

FIG. 5 is a schematic block diagram of an apparatus for driving a self-emission display panel according to an exemplary embodiment of the present invention. Only blocks related to the exemplary embodiment of the present invention are illustrated in FIG. 5, and illustrations and descriptions of blocks obscuring the essential points of the present invention will be omitted.

Referring to FIG. 5, an apparatus 500 for driving a self-emission display panel according to the present embodiment includes a sustain pulse (STP) controller 510, a sub-field (SF) controller 520, an address electrode driver 530, a sustain/scan electrode driver 540 and a self-emission display panel 550.

The STP controller 510 calculates an automatic power controller (APC) level, which varies according to an average signal level (ASL) of image data having an input grayscale, and outputs an input STP corresponding to the calculated APC level.

If the ASL of the image data is greater than a reference ASL, the STP controller 510 transforms the input grayscale to generate an output grayscale, calculates an APC level of the image data having an output grayscale, and outputs an output STP corresponding to the calculated APC level.

The SF controller 520 applies a dithering method to each SF corresponding to the input grayscale to generate SF data for expressing the input grayscale so that the number of cells simultaneously generated in a SF is reduced, i.e., a ratio of the number of cells does not exceed 100%.

In the dithering method, turning on or off of a SF expressed with ‘1’ or ‘0’ is expressed with each fraction to reduce the number of cells simultaneously emitting light in a SF so as to reduce a peak current. For this purpose, the SF controller 520 performs dithering using N cells and expresses fractions in the unit of 1/N.

For example, the SF controller 520 performs dithering using four cells and reduces a peak current to a half of a maximum value if a SF uses grayscales from “0” to “2/4.”

The address electrode driver 530 generates an address driving signal corresponding to the input grayscale from the SF data generated by the SF controller 520 to drive the self-emission display panel 550.

The sustain/scan electrode driver 540 generates sustain/scan pulses from the STP output from the STP controller 510 to drive the self-emission display panel 550.

The self-emission display panel 550 is a display panel which adjusts luminance of each cell according to an emission time and thus may be an AMOLED, a PDP, a SED, or a FED.

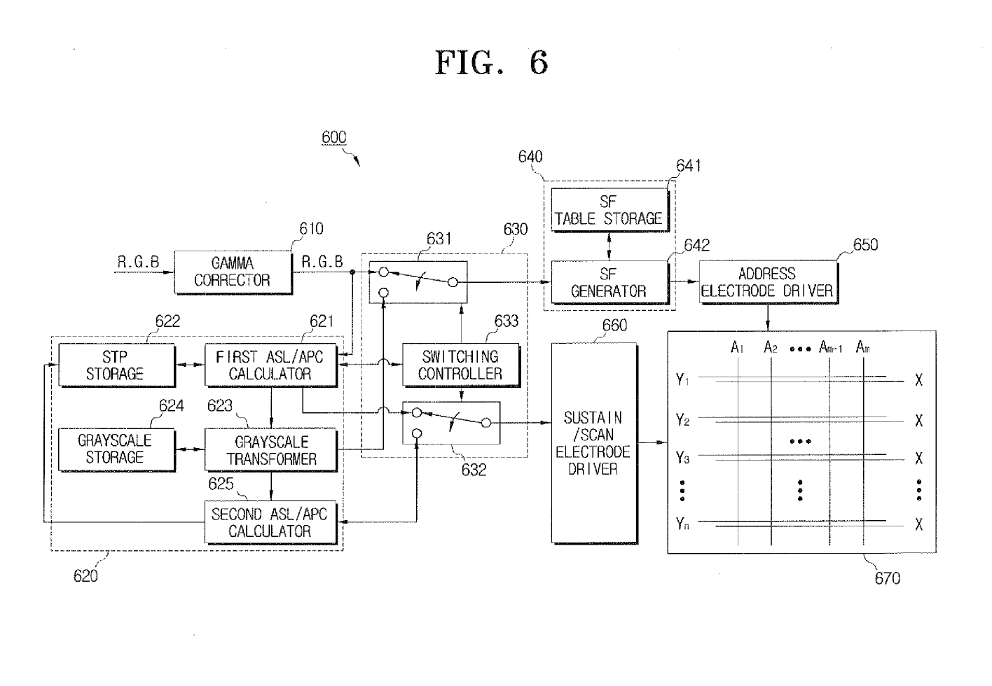

FIG. 6 is a schematic block diagram of an apparatus for driving a self-emission display panel according to another exemplary embodiment of the present invention. Referring to FIG. 6, an apparatus 600 for driving a self-emission display panel according to the present embodiment includes a gamma corrector 610, a STP controller 620, a switching unit 630, a SF controller 640, an address electrode driver 650, a sustain/scan electrode driver 660, and a self-emission display panel 670.

The gamma corrector 610 performs gamma correction on input R, G, and B image data to linearly transform luminance depending on a grayscale value of an image signal and outputs the transformed luminance to a first switch 631. Here, the input R, G, and B image data each has an input grayscale. The input grayscale varies depending on the number of SFs into which a field and/or frame is time divided. For example, if a field and/or frame is divided into four SFs, an input grayscale is expressed with one of grayscales from “0” to “15.”

The STP controller 620 calculates an APC level varying depending on an ASL of image data having an input grayscale and outputs a STP corresponding to the calculated APC level.

In more detail, if the ASL of the image data is less than or equal to a reference ASL, the STP controller 620 outputs an input STP corresponding to an APC level of image data having an input grayscale and generates SF data using dithering on-off data of each SF corresponding to the input grayscale.

If the ASL of the image data is greater than the reference ASL, the STP controller 620 transforms the input grayscale to generate an output grayscale, calculates an APC level of image data having an output grayscale, and outputs an output STP corresponding to the APC level of the image data having the output grayscale.

Here, the reference ASL is a level necessary for fixing the number of STPs used for emitting light from a cell. In the present embodiment, if a load factor is 47%, i.e., image data uses a grayscale 15, a grayscale 7 is used as a reference ASL. However, the load factor for determining the reference ASL may be changed within, for example, a range between 20% and 80%. The contents related to the load factor will be described later.

For this purpose, the STP controller 620 includes a first ASL/APC calculator 621, a STP storage 622, a grayscale transformer 623, a grayscale storage 624, and a second ASL/APC calculator 625.

If a calculated input ASL is less than or equal to a reference ASL, the first ASL/APC calculator 621 calculates the APC level of the image data having an input grayscale using the calculated input ASL, outputs the input STP corresponding to the APC level of the calculated input grayscale to a second switch 632, and outputs flag “0” to a switching controller 633.

Thus, the switching controller 633 controls the first switch 631 to switch the gamma corrector 610 so as to switch the image data having the input grayscale and controls the second switch 632 to switch the input STP output from the first ASL/APC calculator 621.

Here, the first ASL/APC calculator 621 calculates the input ASL using Equation 1 and calculates the APC level of the input grayscale using Equation 2:

$$Input ASL = \frac{Σ Gray Scale of Each Sub - Cell}{Total Number of Sub - Cells} \qquad EQN . ( 1 )$$

wherein “Input ASL” denotes average grayscales of all of sub-cells as the ASL of the image data having the input grayscale, “Sub-Cells” denotes R, G, and B cells, and “Total Number of Sub-Cells” denotes a total number of cells to be displayed on the self-emission display panel 670.

If the image data uses a grayscale 15, all cells emit light with a grayscale 15, i.e., with Full White of grayscale “15,” the ASL is “15,” i.e., ASLmax.

A load factor may be expressed using a ratio of total cells to be currently displayed to all cells, i.e.,

$$\frac{ASL}{ASL max} .$$

### Thus, if the all cells are expressed with Full White as a maximum grayscale, the load factor is 100%. If the all cells are expressed with black, the load factor is 0%.

$$APC Level = \frac{C}{Input ASL} \qquad EQN . ( 2 )$$

wherein “C” denotes a constant, e.g., a consumed power set to be used in the apparatus 600 of the present embodiment, “Input ASL” denotes the ASL calculated using Equation 1, and “APC Level” denotes a level on which the consumed power is maintained and which varies the number of STPs simultaneously emitting light in one (1) frame according to the ASL.

Here, when the number of STPs applied to a plurality of sub-fields is minimum, i.e., the ASL or the load factor is maximum, the APC level is set to “1.” When the ASL is decreased, the APC level is increased.

After the APC level is calculated, the first ASL/APC calculator 621 confirms a STP allocated with respect to each of APC levels stored in the STP storage 622 and outputs the confirmed STP as an input STP to the second switch 632.

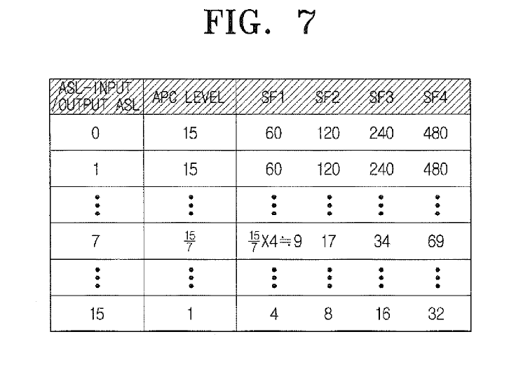

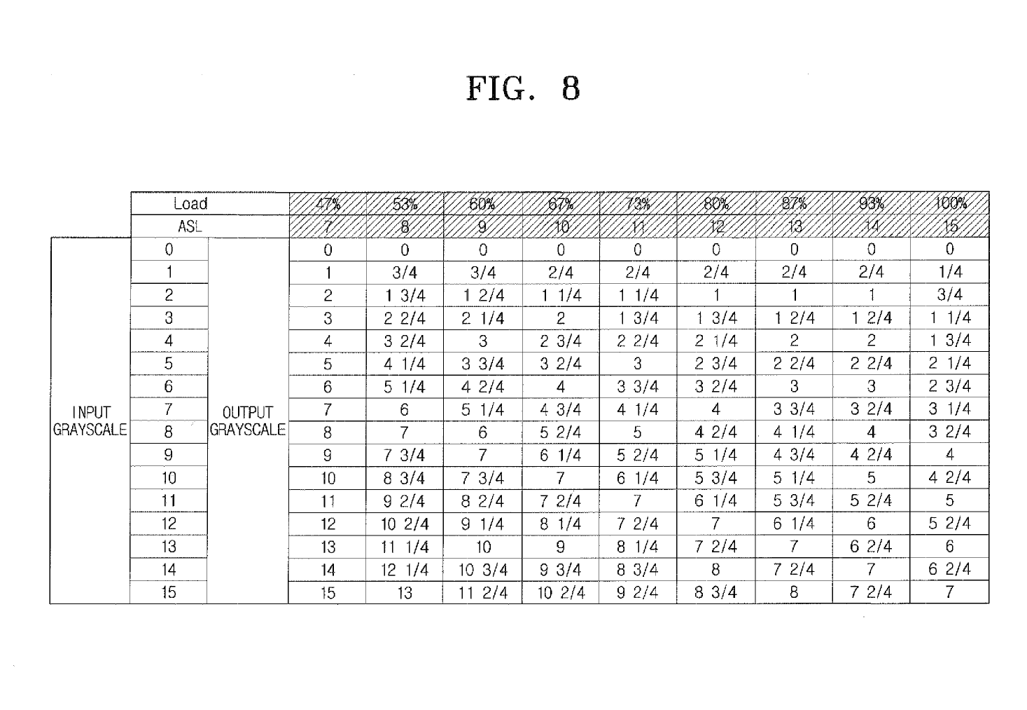

FIG. 7 is an APC table illustrating examples of STPs allocated with respect to APC levels. Referring to FIG. 7, an APC level is inversely proportional to an input or output ASL. Also, the number of STPs allocated to first through fourth SFs (SF1-SF4) is adjusted by the number of STPs allocated when the APC level and the input or output ASL is each “15,” i.e., when APC level is “1.” Here, the number of SFs may be changed when the apparatus 600 is designed. In the present invention, the number of SFs is four (4).

Referring to FIG. 6 again, if the calculated input ASL is greater than the reference ASL, the first ASL/APC calculator 621 outputs the image data having the input grayscale to the grayscale transformer 623 and outputs flag “1” to the switching controller 633. Thus, the switching controller 633 controls the first switch 631 to switch the grayscale transformer 623 and controls the second switch 632 to switch the output STP output from the second ASL/APC calculator 625.

The grayscale transformer 623 transforms the input grayscale of the image data output from the first ASL/APC calculator 621 to generate the output grayscale using a table as shown in FIG. 8. This is to fix the APC level of the output grayscale if the ASL of the input grayscale is greater than the reference ASL so as to maintain the number of output STPs and a consumed power constant.

The grayscale transformer 623 outputs the image data having the generated output grayscale to the first switch 631. Here, the output grayscale output from the grayscale transformer 623 is expressed from “0” to fractions of 1/N. Here, N denotes the number of cells which are used by a SF generator 642 to perform dithering.

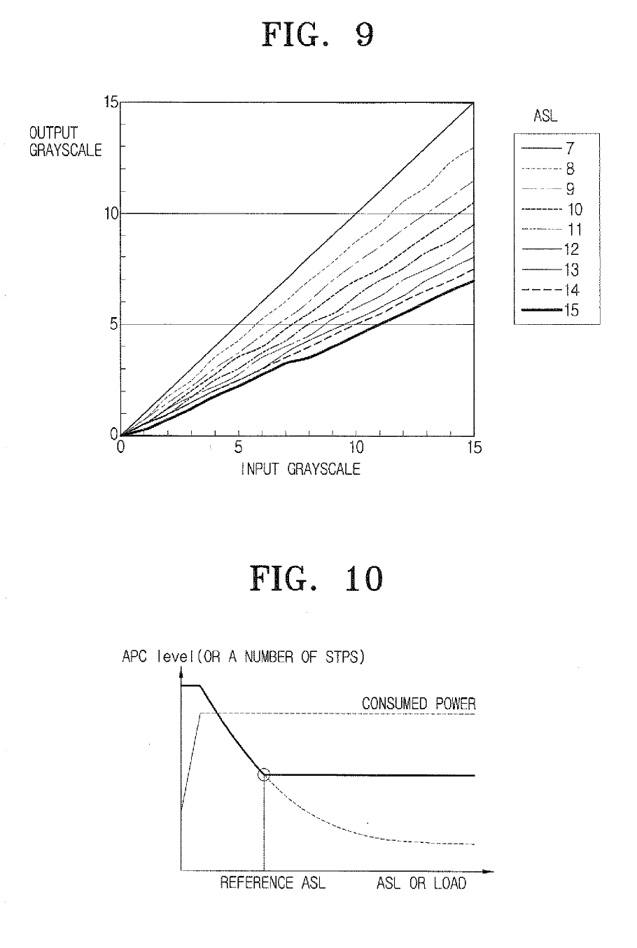

FIG. 8 is a table illustrating examples of output grayscales into which input grayscales are transformed by the grayscale transformer 623 of FIG. 6 according to load factors or ASLs. Here, the output grayscales are stored in the grayscale storage 624. The input grayscales and output grayscales illustrated in FIG. 8 are shown on a graph of FIG. 9. In other words, FIG. 9 is a graph illustrating the output grayscales into which the input grayscales are transformed if input ASLs are from “7” to “15.”

The output grayscales are calculated using Equation 3. Here, the output grayscales may be designed to be calculated and stored in the grayscale storage 624 in advance or calculated by the grayscale transformer 623 using Equation 3:

$$Output GrayScale = \frac{i ( N \times Input GrayScale \times \frac{Reference ASL}{Input ASL} )}{N} \qquad EQN . ( 3 )$$

wherein “i” denotes an integer, “N” denotes the number of cells used for dithering, “Input ASL” denotes the ASL calculated by the first ASL/APC calculator 621.

The second ASL/APC calculator 625 calculates the APC level of the output grayscale input from the grayscale transformer 623 and outputs the output STP corresponding to the calculated APC level of the output grayscale.

In more detail, the second ASL/APC calculator 625 calculates the APC level of the output grayscale using Equation 4:

$$Output ASL = \frac{Reference ASL}{Input ASL} \times Input ASL = Reference ASL = Constant \qquad EQN . ( 4 )$$

In other words, in an exemplary embodiment of the present invention, if the calculated input ASL is greater than the reference ASL, an output ASL corresponding to a calculated output grayscale is calculated. Thus, an APC level is determined depending on the output ASL to maintain the APC level constant. This is because a grayscale is reduced if the APC level is determined based on the input ASL, a luminance is reduced by

$$\frac{Reference ASL}{Input ASL} ,$$

and a consumed power is reduced.

This is shown on a graph of FIG. 10. Referring to FIG. 10, if the calculated input/output ASL is greater than the reference ASL, the APC level and the consumed power are maintained constant in the present invention unlike an APC level reduced in the prior art.

In other words, if each cell of the image data is expressed with total 15 grayscales, and cells expressed with 8 or more grayscale are expressed as SFs without transforming their grayscales, luminance of each of the cells is reduced by 7/ASL and consumed power is reduced. Thus, in one exemplary embodiment, the grayscale transformer 623 transforms grayscales as described above. Also, if the ASL of the output grayscale is more than or equal to “7,” the second ASL/APC calculator 625 fixes the ASL to “7” to fix the APC level as illustrated in FIG. 10.

The second ASL/APC calculator 625 reads the output STP corresponding to the calculated output APC level from the STP storage 622 and then outputs the output STP to the second switch 632.

The switching unit 630 switches the image data output from the gamma corrector 610 or the grayscale transformer 623 and the STP output from the first ASL/APC calculator 621 or the second ASL/APC calculator 625. For this purpose, the switching unit 630 includes the first and second switches 631 and 632 and the switching controller 633.

The first switch 631 switches the image data having the input grayscale or the image data having the output grayscale and outputs the switched image data to the SF generator 642, wherein the image data having the input grayscale is output from the gamma corrector 610 and the image data having the output grayscale is output from the grayscale transformer 623.

The second switch 632 switches the input STP output from the first ASL/APC calculator 621 or the output STP output from the second ASL/APC calculator 625 and outputs the switched input or output STP to the sustain/scan electrode driver 660.

The switching controller 633 controls switching operations of the first and second switches 631 and 632 according to a flag provided from the first ASL/APC calculator 621. In more detail, if flag “0” is input from the first ASL/APC calculator 621, the switching controller 633 controls the first and second switches 631 and 632 to switch the gamma corrector 610 and the first ASL/APC calculator 621.

If flag “1” is input from the first ASL/APC calculator 621, the switching controller 633 controls the first and second switches 631 and 632 to switch the grayscale transformer 623 and the second ASL/APC calculator 625.

In one exemplary embodiment the SF controller 640 applies a dithering method to each SF corresponding to the input grayscale to generate SF data for expressing the input grayscale so as to reduce the number of cells simultaneously emitting light in a SF. In other words, the SF controller 640 generates SF data necessary for forcing a ratio of the number of cells simultaneously emitting light not to be 100%, more than 90% of cells not to simultaneously emit light, or the number of cells simultaneously emitting light not to exceed 50% of a total number of cells.

For this purpose, the SF controller 640 includes a SF table storage 641 and the SF generator 642.

The SF table storage 641 stores dithering on-off data of each SF corresponding to grayscales of the image data.

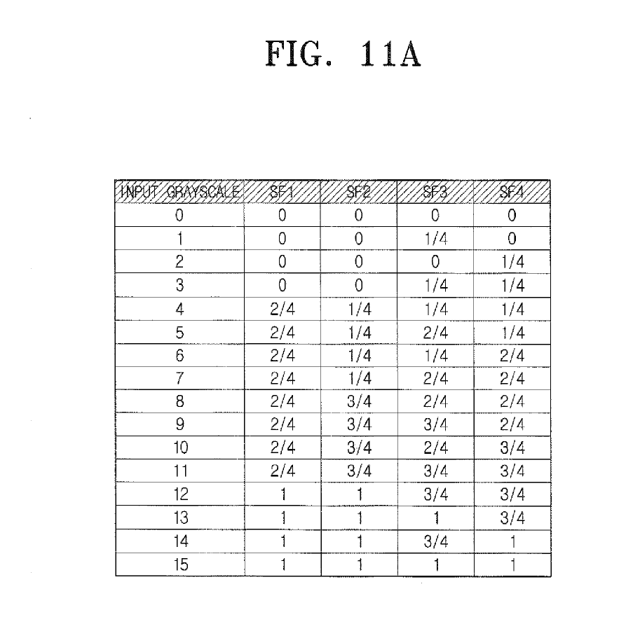

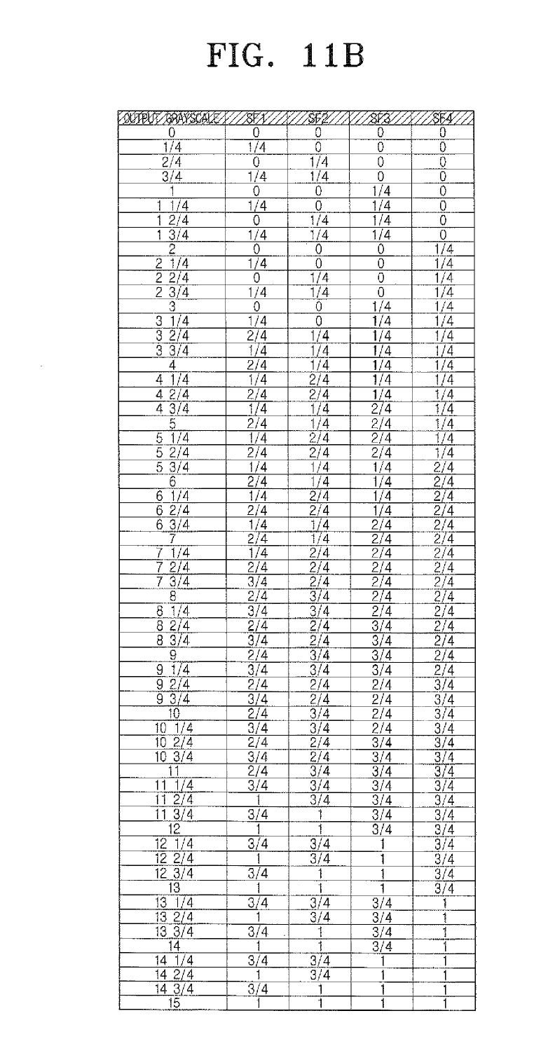

FIG. 11A is a table illustrating examples of the first dithering on-off data stored in the SF table storage 641 of FIG. 6, and FIG. 11B is a table illustrating examples of the second dithering on-off data stored in the SF table storage 641 of FIG. 6. Here, if the table of FIG. 8 is combined with the table of FIG. 11B so that ASL=12, SFs are determined.

If the first ASL/APC calculator 621 of FIG. 6 outputs the flag “0,” i.e., the calculated input ASL is less than or equal to the reference ASL, the SF generator 642 uses the table of FIG. 11A. In the present embodiment, if the input ASL is within a range between “0” and “7,” the SF generator 642 may use the table of FIG. 11A.

For example, if each cell of image data is expressed with total 15 grayscales, a cell having an input grayscale 3 is expressed with dithering data as shown in Table 1 below.

TABLE 1

| | | | | | Input Grayscale (Sum of |
|---|---|---|---|---|---|
| | | | | | Values Obtained through |
| | SF1 | SF2 | SF3 | SF4 | “Weight × SF”) |
| Weight | 1 | 2 | 4 | 8 | — |
| Con- | 1 | 1 | 0 | 0 | (1 × 1) + (2 × 1) + (4 × 0) + |
| ventional | | | | | (8 × 0) = 3 |
| Case | | | | | |
| Present | 0 | 0 | ¼ | ¼ | (1 × 0) + (2 × 0) + (4 × ¼) + |
| Invention | | | | | (8 × ¼) = 3 |

Referring to Table 1, if each cell of the image data is expressed with the total 15 grayscales, the input grayscale 3 can be obtained using dithering data allocated to the present invention. The grayscale 3 in the present invention is the same as the grayscale 3 obtained in the conventional method as illustrated in FIG. 2. In other words, if the input ASL is less than or equal to the reference ASL, the SF generator 642 may generate the SF data using the table shown in FIG. 11A.

If the first ASL/APC calculator 621 outputs the flag “1,” i.e., the calculated input ASL is greater than the reference ASL, the SF generator 642 uses the table of FIG. 11B.

Referring to FIGS. 11A and 11B, input and output grayscales are switched by the first switch 631, and SF1-SF4 denotes first through fourth SFs. Output grayscales are expressed with fractions in the table of FIG. 11B. This is because the output grayscale input from the grayscale transformer 623 is expressed with fractions of 1/N.

The SF generator 642 confirms grayscales input from the first switching 631, i.e., the input and output grayscales of the image data, and reads dithering on-off data corresponding to the confirmed grayscales from the SF table storage 641.

In other words, if the input grayscale is input from the first switch 631, the SF generator 642 reads dithering on-off data using a table as shown in FIG. 11A. If the output grayscale is input from the first switch 631, the SF generator 642 reads dithering on-off data of each cell, i.e., each image data, using a table as shown in FIG. 11B. The SF generator 642 reads dithering on-off data of first through fourth SFs (SF1-SF4) of all of cells positioned in a field/frame.

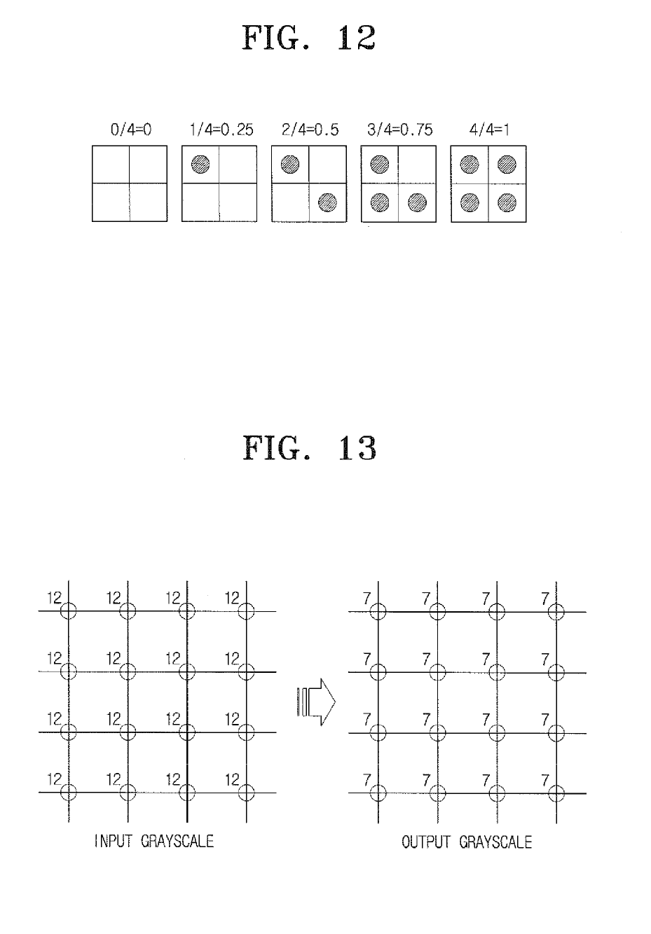

The SF generator 642 also classifies each of the read dithering on-off data into M groups and calculates average values of the dithering on-off data positioned in the M groups. After the SF generator 642 calculates the average values, the SF generator 642 generates SF data of each of the first through fourth SF (SF1-SF4) using grayscale display rules, applying the dithering set as shown in FIG. 12. The SF generator 642 outputs the generated SF data to the address electrode driver 650. Exemplary embodiments related to this will be described below with reference to FIGS. 13 through 15B.

FIG. 12 is a view illustrating an example of grayscale display rules using dithering set by the SF generator 642. In the exemplary embodiment shown in FIG. 12, the SF generator 642 applies dithering using four cells. Thus, if a calculated average value, i.e., calculated average dithering on-off data, is “0,” the SF generator 642 turns off all of the four cells, i.e., all of the four cells are “0.” If the calculated average value is “0.25,” the SF generator 642 turns on only one of the four cells, i.e., only one of the four cells is “1.” If the calculated average value is “0.75,” the SF generator 642 turns on three of the four cells. If the calculated average value is “1,” the sub-field generator 642 turns on all four cells. The grayscale display rules as illustrated in FIG. 12 may be changed and variously realized according to the number of cells applied to dithering.

The address electrode driver 650 generates an address driving signal corresponding to the input or output grayscale, from the SF data input from the SF generator 642, and drives address electrode lines A₁ through Aₘ of the self-emission display panel 670 using the generated address driving signal.

The sustain/scan electrode driver 660 generates sustain/scan pulses based on the input or output STP sent from the second switch 632 and drives the self-emission display panel 670 using the generated sustain/scan pulses.

The self-emission display panel 670 is a display panel which adjusts a luminance of each cell according to an emission time and thus may be an AMOLED, a PDP, an SED, or an FED. If the self-emission display panel 670 is realized as a PDP, the self-emission display panel 670 has the address electrode lines A₁ through Aₘ and sustain/scan electrode lines X and Y₁ through Yₙ as shown in FIG. 6 and discharges cells formed by the electrode lines A₁ through Aₘ and sustain/scan electrode lines X, Y₁ through Yₙ to realize an image. Here, the electrode lines X are driven as common electrodes.

A case where image data of R sub-cells of R, G, and B image data having a 4×4 structure, i.e., the R sub-cells, are all input as a grayscale 12 in the apparatus 600 capable of expressing maximum 15 grayscales will now be described.

FIG. 13 is a view schematically illustrating R sub-cells having a 4×4 structure.

If R sub-cells each having a grayscale 12 are output from the gamma corrector 610, the first ASL/APC calculator 621 calculates the input ASL using Equation 1 above. In other words,

$$Input ASL = \frac{12 \times 16}{16} = 12.$$

Thus, since the input ASL is greater than 7 which is the reference ASL, the first ASL/APC calculator 621 outputs R image data having an input grayscale to the grayscale transformer 623 and flag “1” to the switching controller 633.

The grayscale transformer 623 confirms the output grayscale corresponding to the input grayscale using a table stored in the grayscale storage 624, i.e., the table illustrated in FIG. 8, and outputs the confirmed output grayscale to the first switch 631. Thus, if the input ASL is “12,” output grayscales output from the grayscale transformer 623 are all “7” as shown in FIG. 13B, wherein the output grayscales correspond to the input grayscale 12.

The second ASL/APC calculator 625 calculates output ASL and APC. Here, the output ASL is always “7,” and thus the output APC is “15/7.” The second ASL/APC calculator 625 reads an output STP corresponding to “15/7” in the table of FIG. 7 from the STP storage 622 and outputs the output STP to the second switch 632.

The first switch 631 is controlled by the switching controller 633 to switch the output grayscale input from the grayscale transformer 623, and the second switch 632 is controlled by the switching controller 633 to switch the output STP input from the second ASL/APC calculator 625.

Since the output grayscales of the 4×4 image data input from the first switch 631 are all “7,” the SF generator 642 reads dithering on-off data of first through fourth SFs (SF1-SF4) corresponding to the output grayscales 7 from the table of FIG. 11B. In other words, the read dithering on-off data is sequentially “2/4,” “1/4,” “2/4,” and “2/4” from the first through fourth SFs (SF1-SF4) and is the same in all of 12 R sub-cells.

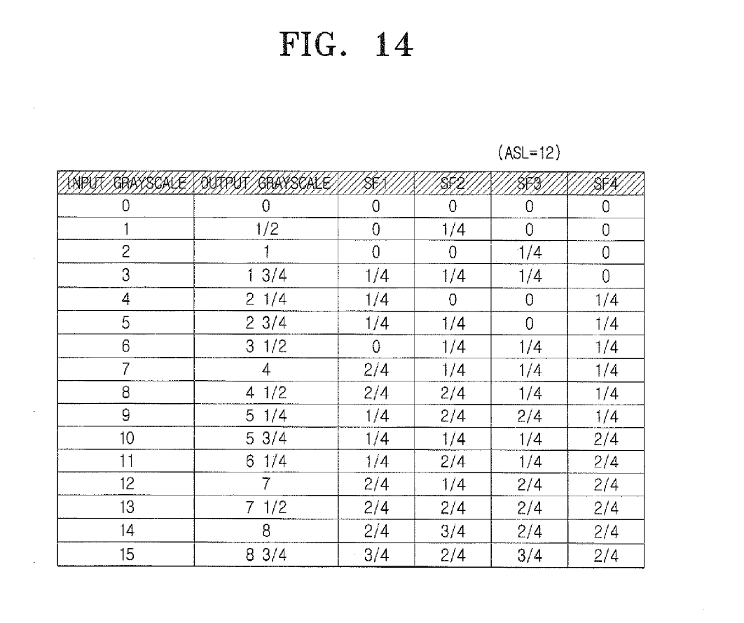

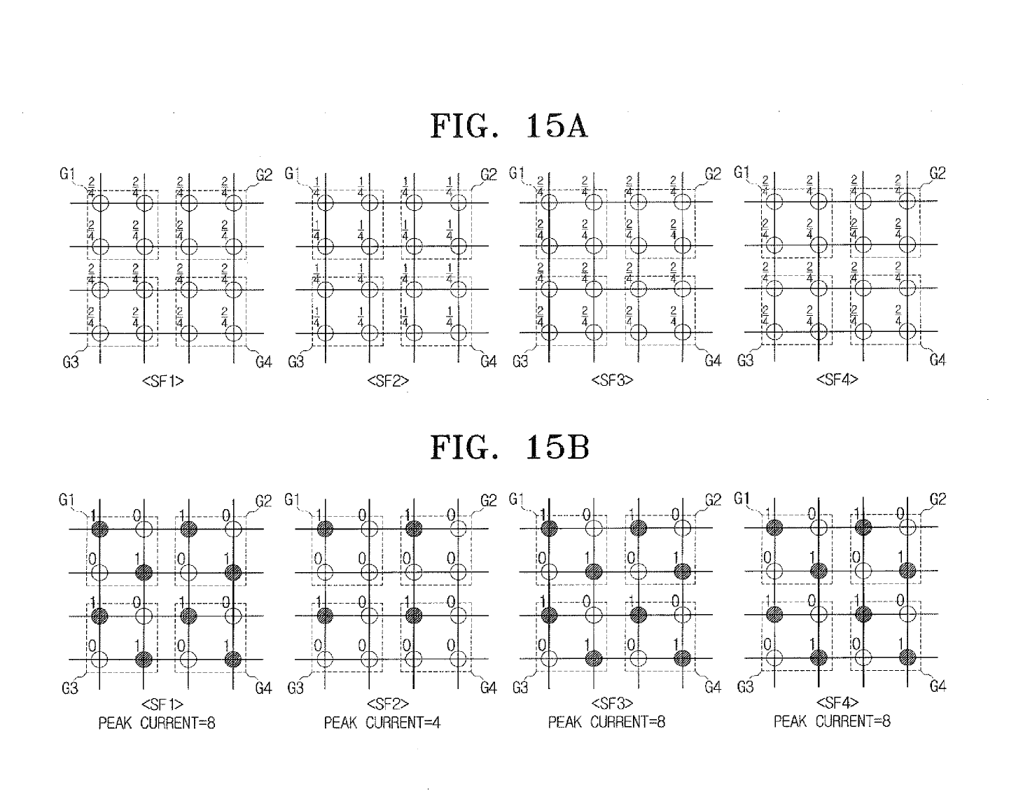

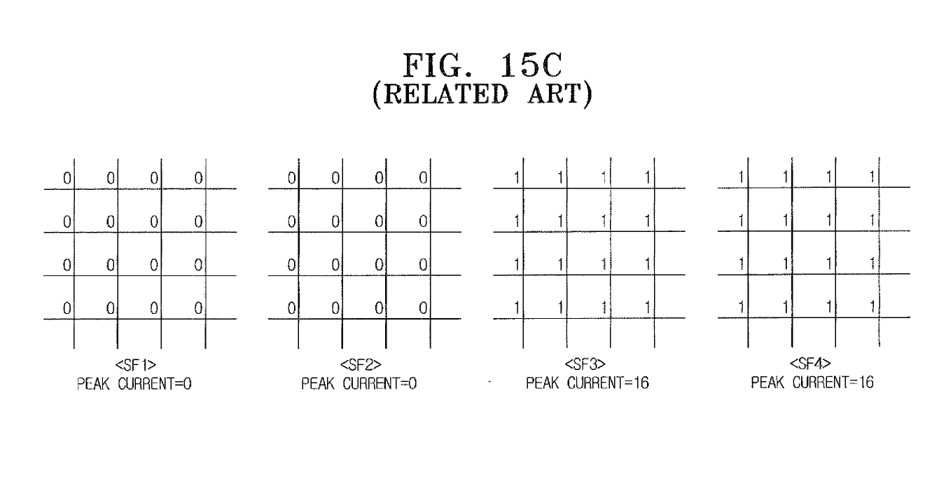

FIG. 14 is a table illustrating output grayscales corresponding to input grayscales and dithering on-off data set for each of the output grayscales when an input ASL is “12,” and FIGS. 15A and 15B are views illustrating a process of applying dithering to the output grayscales illustrated in FIG. 13. Here, a table as shown in FIG. 14 is stored in the SF table storage 641.

Referring to FIGS. 13 through 15B, the SF generator 642 reads dithering on-off data of each of first through fourth SFs (SF1-SF4) corresponding to output grayscales generated, as illustrated in FIG. 13 from the table of FIG. 14 to perform the process illustrated in FIGS. 15A and 15B. Numerals shown in FIG. 15A denote turning on and off of each of first through fourth SFs (SF1-SF4) necessary for applying dithering, and “0” or “1” shown in FIG. 15B denotes turning on or off of each of the first through fourth SFs (SF1-SF4) during the application of dithering.

In more detail, dithering on-off data of an output grayscale 7 of the first SF (SF1) is all “2/4” as shown in FIG. 15A, dithering on-off data of an output grayscale 7 of the second SF (SF2) is all “1/4,” and dithering on-off data of output grayscales 7 of the third and fourth SFs (SF3 and SF4) is all “2/4” as shown in FIG. 15A.

Thus, the SF generator 642 classifies the read dithering on-off data of each of the first through fourth SFs (SF1-SF4) into 2×2 groups (marked with dotted lines) and calculates average values of dithering on-off data positioned in the 2×2 groups. Referring to FIG. 15B, an average value of each group in the first SF (SF1) is “2/4,” an average value of each group in the second SF (SF2) is “1/4,” and average values of each group in third and fourth SFs (SF3 and SF4) are “2/4.”

After the SF generator 642 calculates the average values, the SF generator 642 generates SF data of each of the first through fourth SFs (SF1-SF4) as illustrated in FIG. 15B using grayscale display rules, applying the dithering set as illustrated in FIG. 12. In other words, since a calculated average value of a first group G1 is “2/4,” the SF generator 642 applies dithering rules corresponding to “2/4,” illustrated in FIG. 12, to the first group G1 shown in FIG. 15B.

The dithering rules are equally applied to the second through fourth SFs (SF2-SF4), and thus the descriptions of the application of the dithering rules to the second through fourth SFs (SF2-SF4) will be omitted. However, peak currents generated in the first through fourth SFs (SF1-SF4) of FIG. 15B are respectively “8,” “4,” “8” and “8.” Here, the peak currents respectively denote numbers of cells which are turned on, i.e., expressed with “1.”

After the process of FIG. 15B is completely performed, the SF generator 642 outputs the generated SF data to the address electrode driver 650.

FIG. 15C is a view illustrating a case where SF data is generated using an existing method, without transforming output grayscales as described above, if image data of R sub-cells of R, G, and B image data having a 4×4 structure, i.e., R sub-cells, are all input as grayscale “12.”

Referring to FIGS. 2 and 15C, 12 cells having input grayscales 12 each have SF on-off data “0,” “0,” “1” and “1” of first through fourth SFs (SF1-SF4). Thus, the SF on-off data of each of the first through fourth SFs (SF1-SF4) is shown as in FIG. 15C, and peak currents of the first through fourth SFs (SF1-SF4) are respectively “0” “0,” “16” and “16.”

In other words, comparing the result of FIG. 15B to the result of FIG. 15C, a peak current can be reduced, and a luminance of a cell can be maintained.

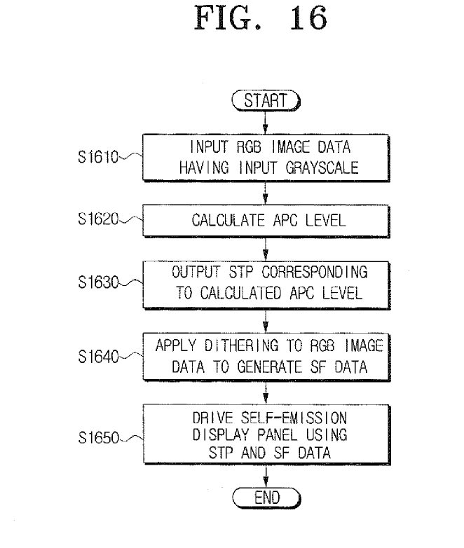

FIG. 16 is a flowchart of a method of driving a self-emission display panel, according to an exemplary embodiment of the present invention. Referring to FIGS. 5 and 16, in operation S1610, R, G, and B image data having an input grayscale is input. In operation S1620, the STP controller 510 calculates an APC level which varies according to an ASL of the R, G, and B image data having the input grayscale.

In operation S1630, the STP controller 510 outputs an STP corresponding to the calculated APC level to the sustain/scan electrode driver 540.

In operation S1640, the SF controller 520 applies a dithering method to each SF corresponding to the input grayscale to generate SF data for expressing the input grayscale so that the number of cells simultaneously emitting light in a SF is reduced, i.e., a ratio of the number of the cells simultaneously emitting light is not 100%.

In operation S1650, the sustain/scan electrode driver 540 drives the self-emission display panel 550 using the STP output in operation S1630, and the address electrode driver 530 drives the self-emission display panel 550 using the SF data generated in operation S1640.

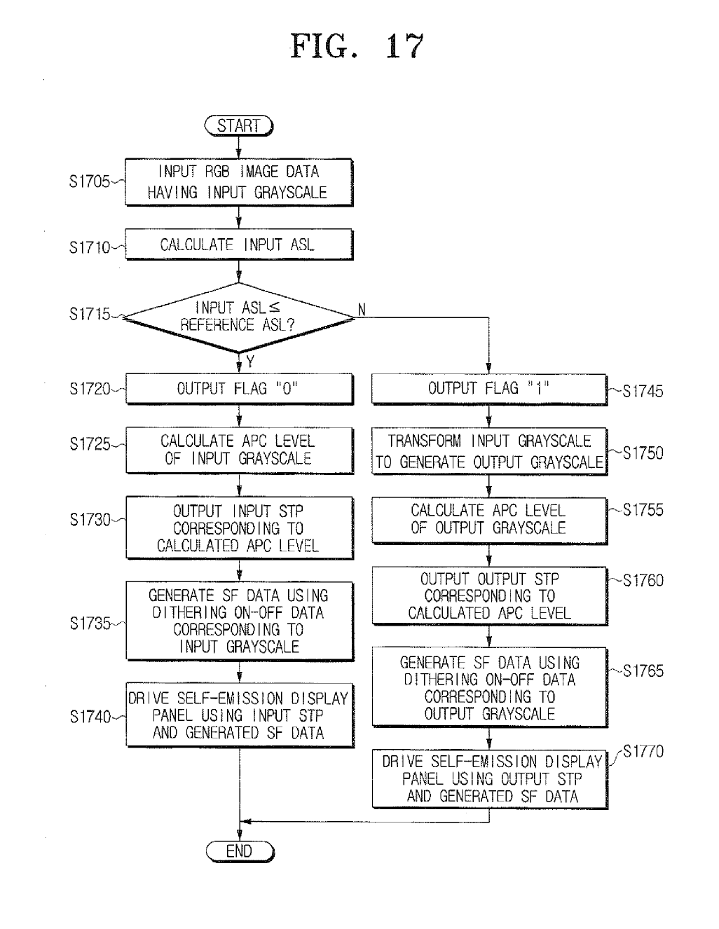

FIG. 17 is a flowchart of a method of driving a self-emission display panel illustrated FIG. 6, according to another exemplary embodiment of the present invention. Referring to FIGS. 6 through 15 and 17, in operation S1705, R, G, and B image data having an input grayscale is input. In operation S1710, the first ASL/APC calculator 621 calculates an input ASL of the R, G, and B image data having the input grayscale.

If the calculated input ASL is less than or equal to a reference ASL in operation S1715, the first ASL/APC calculator 621 provides flag “0” to the switching controller 633 in operation S1720 and calculates an APC level of the input grayscale in operation S1725.

In operation S1730, the first ASL/APC calculator 621 confirms an input STP corresponding to the calculated APC level from the STP storage 622 and outputs the input STP to the second switch 632. Here, the switching controller 633 controls the first switch 631 using the flag “0” to switch the image data input from the gamma corrector 610 and provide the switched image data to the SF generator 642 and controls the second switch 632 using the flag “0” to switch the input STP input from the first ASL/APC calculator 621 and provide the switched input STP to the sustain/scan electrode driver 660.

In operation S1735, the SF generator 642 generates SF data using the input grayscale of the image data input from the first switch 631. In more detail, the SF generator 642 generates the SF data using dithering on-off data corresponding to the input grayscale of the image data.

In operation S1740, the sustain/scan electrode driver 660 drives electrode lines “X” and “Y” using the input STP generated in operation S1730, and the address electrode driver 650 drives address electrode lines “A” using the SF data output in operation S1735.

If the calculated input ASL is greater than the reference ASL in operation S1715, the first ASL/APC calculator 621 provides flag “1” to the switching controller 633 in operation S1745, and the grayscale transformer 623 transforms the input grayscale to generate an output grayscale in operation S1750.

The second ASL/APC calculator 625 calculates an APC level of the output grayscale in operation S1755 and sends an output STP corresponding to the calculated APC level to the second switch 632 in operation S1760. Here, the switching controller 633 controls the first switch 631 using the flag “1” to switch the image data input from the grayscale transformer 623 and provide the switched image data to the SF generator 642 and controls the second switch 632 using the flag “1” to switch the output STP input from the second ASL/APC calculator 625 and provided the switched output STP to the sustain/scan electrode driver 660.

In operation S1765, the SF generator 642 generates SF data using the output grayscale of the image data input from the first switch 631. In more detail, the SF generator 642 generates the SF data using dithering on-off data corresponding to the output grayscale of the image data.

In operation S1770, the sustain/scan electrode driver 660 drives the electrode lines “X” and “Y” using the output STP generated in operation S1760, and the address electrode driver 650 drives the address electrode lines “A” using the SF data output in operation S1765.

Here, a generated peak current is reduced and a consumed power is maintained constant, as illustrated in FIGS. 15B compared to 15C.

In the exemplary embodiment described with reference to FIGS. 5 through 17, a point at which the number of STPs is fixed, i.e., a point at which the reference ASL is determined, may be applied with a change of a load factor within a range between 20% and 80%. Also, one or more points at which the reference ASL is determined may be applied when the number of cells used for dithering is required to be changed or a ratio for reducing a peak current is required to be changed according to an input screen.

Also, the number of cells used for dithering may be variously changed from about 2×1 to about 4×4 and more. The peak current may be further reduced with in an increase in the number of cells used for dithering.

As described above, in an exemplary embodiment of an apparatus and a method for driving a self-emission display panel according to the present invention, if a load factor exceeds 50%, the number of STPs used for emitting light from cells can be reduced. Also, a consumed power can be maintained constant. In other words, a dithering method can be applied to reduce the number of cells simultaneously emitting light in a SF so as to reduce a peak current generated during driving of the self-emission display panel and maintain the consumed power constant.

Also, in another embodiment of the present invention, a switching element such as a FET having a small capacity can be used to provide an effect of saving cost.

In addition, grayscales used during driving of the self-emission display panel can be expressed with fractions to solve a luminance difference problem or a luminance deviation problem.

Moreover, the peak current can be minimized to apply a normal voltage to the self-emission display panel so that each cell normally discharges.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A self-emission display panel driving apparatus, comprising:
a sustain pulse (STP) controller which calculates an automatic power control (APC) level of image data having an input grayscale and outputs a STP corresponding to the calculated APC level;
a sub-field (SF) controller which applies a dithering method to each SF corresponding to the input grayscale to generate SF data for expressing the input grayscale so as to reduce the number of cells simultaneously emitting light in the SF;
a sustain/scan driver which generates sustain/scan pulses from the output STP to drive the self-emission display panel; and
an address electrode driver which generates an address driving signal corresponding to the input grayscale from the generated SF data to drive the self-emission display panel.

2. The apparatus of claim 1, wherein if an average signal level (ASL) of the input grayscale of the image data is greater than a reference ASL, the STP controller transforms the input grayscale to generate an output grayscale and calculates an APC level of the output grayscale.

3. The apparatus of claim 2, wherein if the ASL of the input grayscale is greater than the reference ASL, the STP controller fixes the APC level of the output grayscale to maintain a number of generated output STPs and a consumed power constant.

4. The apparatus of claim 2, wherein the STP controller comprises:
a first ASL/APC calculator which calculates the ASL from the input grayscale of the image data and outputs the image data if the ASL is greater than the reference ASL;
a grayscale transformer which transforms the input grayscale of the output image data to generate the output grayscale; and
a second ASL/APC calculator which calculates the APC level of the generated output grayscale and outputs an output STP corresponding to the calculated APC level of the output grayscale.

5. The apparatus of claim 1, wherein the STP controller comprises:
a first ASL/APC calculator which calculates an average signal level (ASL) from the input grayscale of the image data, wherein if the calculated ASL is less than or equal to the reference ASL, the first ASL/APC calculator calculates the APC level of the input grayscale using the calculated ASL and outputs an input STP corresponding to the calculated APC level of the input grayscale.

6. The apparatus of claim 4, wherein the grayscale transformer transforms the input grayscale into the output grayscale using:
$$Output Gray Scale = \frac{i ( N \times Input Gray Scale \times \frac{Reference ASL}{Input ASL} )}{N}$$
wherein i denotes an integer, N denotes a number of cells used for dithering, and Input ASL denotes the ASL from the input grayscale of the image data calculated by the first ASL/APC calculator.

7. The apparatus of claim 4, wherein the generated output grayscale is expressed with a fraction from “0” to “1/N”, where N denotes a number of cells used for dithering.

8. The apparatus of claim 1, wherein the SF controller generates the SF data using dithering on-off data set in each SF according to the input grayscale, the dithering on-off data is expressed with fractions between “0” and “1.”

9. The apparatus of claim 2, wherein the SF controller comprises:
a SF storage which stores dithering on-off data of each SF corresponding to the input and the output grayscales; and
a SF generator which generates the SF data using the set dithering on-off data of the each SF corresponding to one of the input and the output grayscales.

10. The apparatus of claim 1, wherein the self-emission display panel is one of an active-matrix organic light emitting diode (AMOLED), a plasma display panel (PDP), a surface-conduction electron-emitter display (SED), and a field emission display (FED).

11. A method of driving a self-emission display panel, comprising:
calculating an automatic power control (APC) level of image data having an input grayscale and outputting a sustain pulse (STP) corresponding to the calculated APC level;
generating sub-field (SF) data for applying a dithering method to each SF corresponding to the input grayscale to generate SF data for expressing the input grayscale so as to reduce the number of cells simultaneously emitting light in the SF;
generating sustain/scan pulses from the output STP to drive the self-emission display panel; and
generating an address driving signal corresponding to the input grayscale from the generated SF data to drive the self-emission display panel.

12. The method of claim 11, wherein if an average signal level (ASL) of the image data is greater than a reference ASL, the input grayscale is transformed to generate an output grayscale, and an APC level of the output grayscale is calculated.

13. The method of claim 12, wherein if the ASL of the input grayscale is greater than the reference ASL, the APC level of the output grayscale is fixed to maintain a number of generated output STPs and a consumed power constant.

14. The method of claim 12, wherein the outputting of the STP comprises:
calculating the ASL from the input grayscale of the image data and outputting the image data if the ASL is greater than the reference ASL;
transforming the input grayscale of the output image data to generate the output grayscale; and
calculating the APC level of the generated output grayscale and outputting an output STP corresponding to the calculated APC level of the output grayscale.

15. The method of claim 11, wherein the outputting of the STP comprises:
calculating the ASL from the input grayscale of the image data, wherein if the calculated ASL is less than or equal to the reference ASL, the APC level of the input grayscale is calculated using the calculated ASL, and an input STP corresponding to the calculated APC level of the input grayscale is output.

16. The method of claim 14, wherein the input grayscale is transformed into the output grayscale using Equation below:
$$Output Gray Scale = \frac{i ( N \times Input Gray Scale \times \frac{Reference ASL}{Input ASL} )}{N}$$
wherein i denotes an integer, N denotes a number of cells used for dithering, and Input ASL denotes the calculated ASL.

17. The method of claim 14, wherein the generated output grayscale is expressed with fractions from “0” to “1/N”, where N denotes the number of cells used for dithering.

18. The method of claim 11, wherein the SF data is generated using dithering on-off data set in each SF according to the input grayscale, and the dithering on-off data is expressed with fractions between “0” and “1.”

19. The method of claim 12, wherein the SF data is generated using a dithering on-off data of each SF corresponding to one of the input and output grayscales.

20. The method of claim 11, wherein the self-emission display panel is one of an active-matrix organic light emitting diode (AMOLED), a plasma display panel (PDP), a surface-conduction electron-emitter display (SED), and a field emission display (FED).
